(19) United States
(12) Patent Application Publication
(10) Pub. No.: US 2012/0204111 A1
(43) Pub. Date: Aug. 9, 2012

(54) HIGHER-LEVEL E-MAIL ADDRESS CREATION AT SIGNUP

(75) Inventor: Roderick Carlos Paulino, Renton, WA (US)

(73) Assignee: MICROSOFT CORPORATION, Redmond, WA (US)

(21) Appl. No.: 13/022,536

(22) Filed: Feb. 7, 2011

(51) Int. Cl. G06F 3/048; G06F 15/16

(52) U.S. Cl. 715/733

(57) ABSTRACT

A computing system assisting a user in signing up for an online service using a third-level e-mail address for use in provisioning an online service. A first phase user interface is displayed to the user to assist in creating a third-level domain name. The user may enter the third-level portion of the domain name in this user interface, which in connection with a first-tier domain portion, and a second-level domain portion, formulates a third-level domain name. The third-level domain name is verified for uniqueness. If not sufficiently unique, the process repeats until a sufficiently unique third-level domain name is selected. A second user interface is then displayed that permits a user to enter a prefix, which in combination with the third-level domain name creates a third-level e-mail address. This third-level domain name may then be used as an identifier for an online service and/or to provision an online service.

### BACKGROUND

A variety of services are offered over a network. In some cases, the location of the services is abstracted away from the service consumer. This is often termed a service in the cloud or “online service”. The online service may be partially offered over the Internet and/or some other network, or perhaps even some of the service may be enabled through local means.

In order to gain access to an online service, the user is often guided through a sign-up procedure. Once signed up, the online service may then be provisioned for the user. In some cases, given the proper information, the online service can be automatically provisioned at sign up. As an example, the user identifier created at sign up can be used to automatically provision an online service in some cases.

Third-level e-mail addresses may also be used to automatically provision an online service. Third-level e-mail addresses are e-mail addresses that have a valid third-level domain name. A third-level domain name is a domain name which occupies a third-level namespace or a higher-level namespace in the Domain Name Service (DNS) system. An example of a second-level domain name is microsoft.com. A third-level namespace may have another level of name appended to the left of the parent second-level namespace. For example, contoso.microsoft.com is a fictional example of a third-level namespace. In this context, johndoe@contoso.microsoft.com would be an example of a third-level e-mail since it has a third-level namespace (assuming that the third-level namespace is valid).

There are some cases where a third-level e-mail address may be used to automatically provision an online service, whereas other types of identifiers may not. However, not all users have access to a third-level e-mail address, or perhaps are willing to use their own third-level e-mail address in the signup process.

### BRIEF SUMMARY

At least one embodiment described herein relates to a computing system assisting a user in signing up for an online service using a third-level e-mail address for use in provisioning an online service. A first phase user interface is displayed to the user to assist in creating a third-level domain name. The user may enter the third-level portion of the domain name in this user interface, which in connection with a first-level domain portion, and a second-level domain portion, formulates a third-level domain name. The third-level domain name is verified for uniqueness. If not sufficiently unique, the process repeats until a sufficiently unique third-level domain name is selected. A second user interface is then displayed that permits a user to enter a prefix, which in combination with the third-level domain name creates a third-level e-mail address. This third-level domain name may then be used as an identifier for an online service and/or to provision an online service that users third-level domain names in the provisioning process.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates an example computing system that may be used to employ embodiments described herein;

FIG. 2 illustrates a flowchart of a method for a computing system, such as the computing system of FIG. 1, to assist a user in the creation of the third-level e-mail address for use in signing up for an online service;

FIG. 3 illustrates a first user interface that may be used to allow the user to select a third-level domain portion of a third-level domain name;

FIG. 4 illustrates a second user interface that may be used to allow the user to select a prefix, which in combination with the third-level domain name chosen in the user interface of FIG. 3, creates a third-level e-mail address; and

FIG. 5 illustrates a third user interface that may be used to allow the user to select a password to be used in combination with the third-level e-mail address to authenticate to an online service.

### DETAILED DESCRIPTION

In accordance with embodiments described herein, a computing system assists a user in signing up for an online service using a third-level e-mail address for use in provisioning an online service. A first phase user interface is displayed to the user to assist in creating a third-level domain name. The user may enter the third-level portion of the domain name in this user interface, which in connection with a first-level domain portion, and a second-level domain portion, formulates a third-level domain name. The third-level domain name is verified for uniqueness. If not sufficiently unique, the process repeats until a sufficiently unique third-level domain name is selected. A second user interface is then displayed that permits a user to enter a prefix, which in combination with the third-level domain name creates a third-level e-mail address. This third-level domain name may then be used as an identifier for an online service and/or to provision an online service.

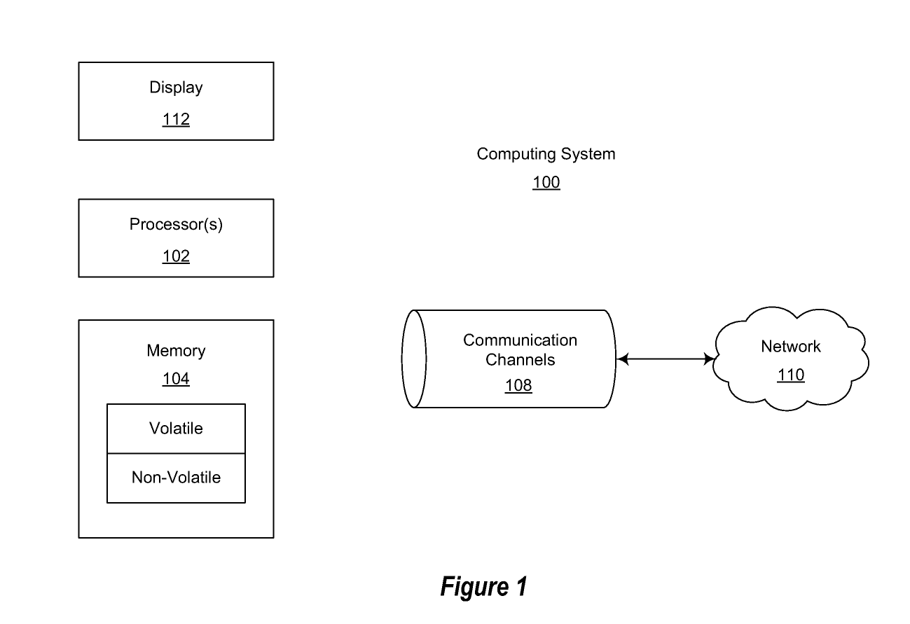

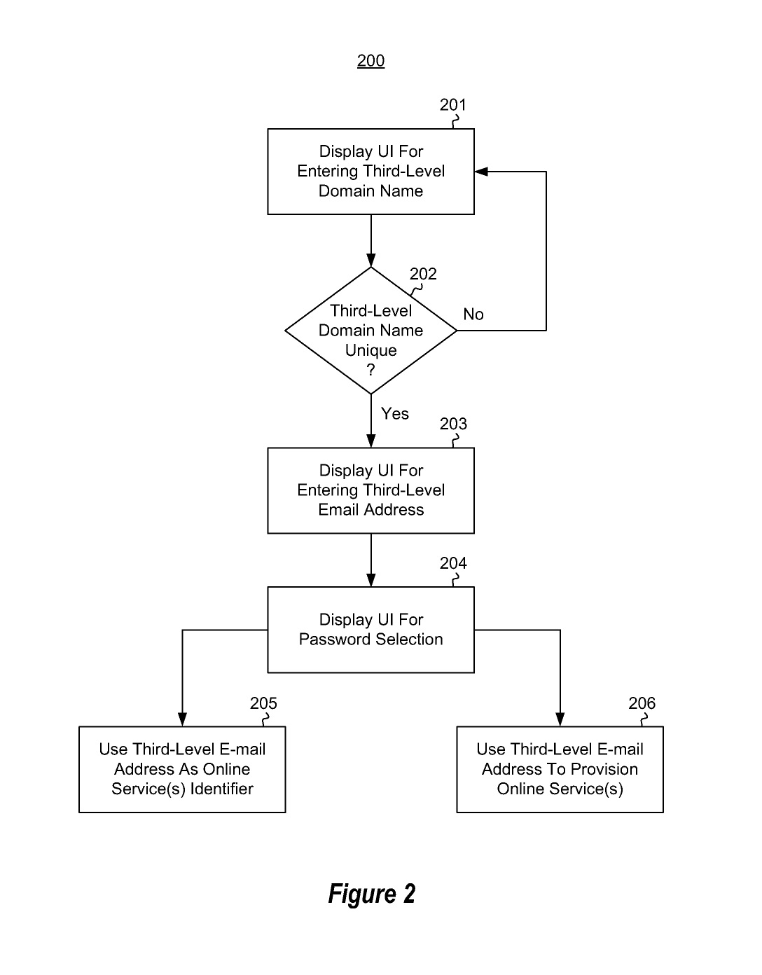

First, some introductory discussion regarding computing systems will be described with respect to FIG. 1. Then, the embodiments of the formulation of a third-level e-mail address will be described with respect to FIGS. 2 through 5.

First, introductory discussion regarding computing systems is described with respect to FIG. 1. Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems. As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110. The computing system may also include a display 112 that may display one or more user interfaces that a user of the computing system may interface with.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

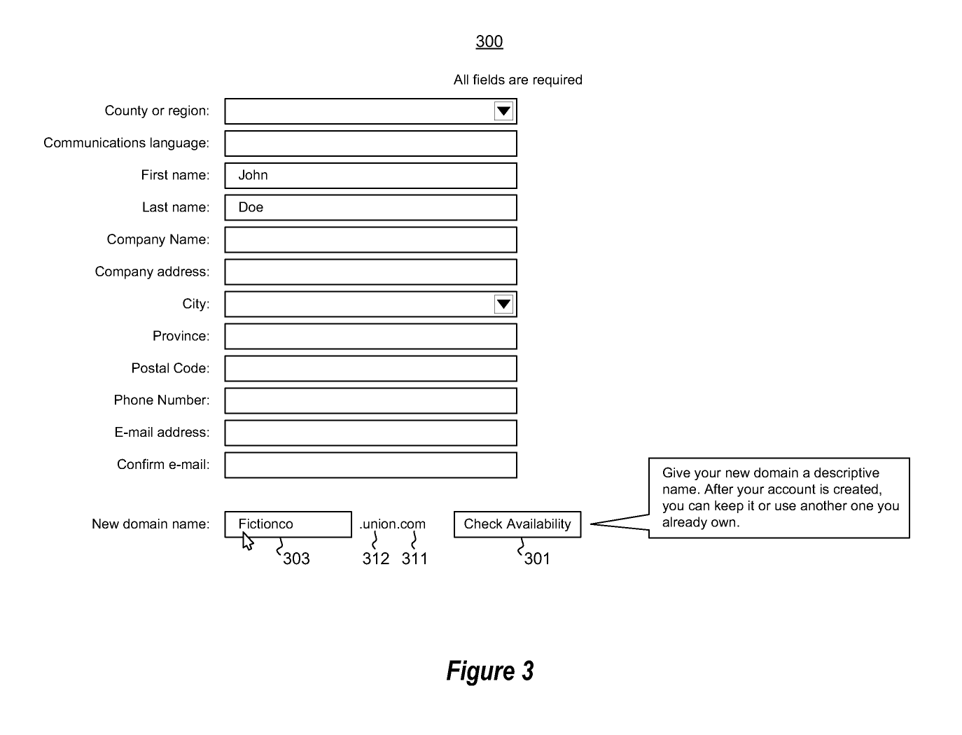

FIG. 2 illustrates a flowchart of a method 200 for a computing system to assist a user in signing up for an online service using a third-level e-mail address for use in provisioning an online service. The method 200 discusses three user interfaces. Examples of these three user interface will be described with respect to the user interfaces 300, 400 and 500 of FIGS. 3, 4 and 5, respectively. Accordingly, the method 200 of FIG. 2 will now be described with frequent reference to the user interfaces of FIGS. 3 through 5. In one embodiment, the computing system that performs the method 200 may be the computing system 100 of FIG. 1. The computing system 100 may perform the method by the processor(s) 102 executing computer-executable instructions that are structured to cause the processor(s) 102 to direct the computing system to perform the method. Such computer-executable instructions may be provided on computer storage media as part of a computer program product.

Referring to the method 200 of FIG. 2, the computing system displays a first user interface that permits a user to enter a third-level domain portion (act 201). The third-level-domain portion is a personalized portion of the domain name, which in connection with a first-level domain portion, and a second-level domain portion, formulates a third-level domain name.

FIG. 3 illustrates a user interface 300 that may be used to allow the user to select a third-level domain portion of a third-level domain name, and represents an example of the user interface of act 201 of the method 200 of FIG. 2. The user enters personalized information into the user interface such as country or region, language, first name, last name, company name, company address, company city, country state or province, postal or zip code, phone number, and so forth. The user also enters and confirms the user's e-mail address. Most of these fields are left blank in order to avoid inadvertently identifying an actual individual or address. However, in practice, the user interface could have these fields filled in.

The first-level domain portion 311 is “.com” and the second-level domain portion 312 is “.union”. These domain portions are combined to form a second-level domain name, with the second-level domain portion shown in context preceding the first-level domain portion. The second-level domain name is “.union.com”, and may be predetermined. This second-level domain name may be owned by the online service provider, giving the online service provider authority to assign third-level domain names derived from the second-level domain name. There is a text box 303 illustrated in which the user can enter a personalized third-level domain portion (in this example “fictionco”). In the context in which the third-level domain portion preceding the second-level domain name “.union.com”, the selected third-level domain name is “fictionco.union.com”. The user completes the selection of the third-level domain name by selecting the “Check Availability” control 301.

Returning to FIG. 2, once the user enters the third-level domain name, the computing system verifies the uniqueness of the third-level domain name (decision block 202). This may involve simply verifying that there are no other identical third-level domain names used as identifiers for the online service. However, to protect against inadvertent identifier collision due to typographic errors, the computing system may verify that there are no similar third-level domain names used as identifiers for the online service.

If the selected third-level domain name is not sufficiently unique (No in decision block 202), the user interface of act 201 (an example of which being the user interface 300 of FIG. 3) may be re-displayed (act 201) so that the user may try another third-level domain name portion. If the selected third-level domain name is sufficiently unique (Yes in decision block 202), the computing system displays a second user interface that permits a user to enter a prefix (act 203), which in combination with the third-level domain name creates a third-level e-mail address. This prefix is a local identifier, which often identifies the individual owner of the e-mail address. The prefix is the portion that precedes the “@” symbol.

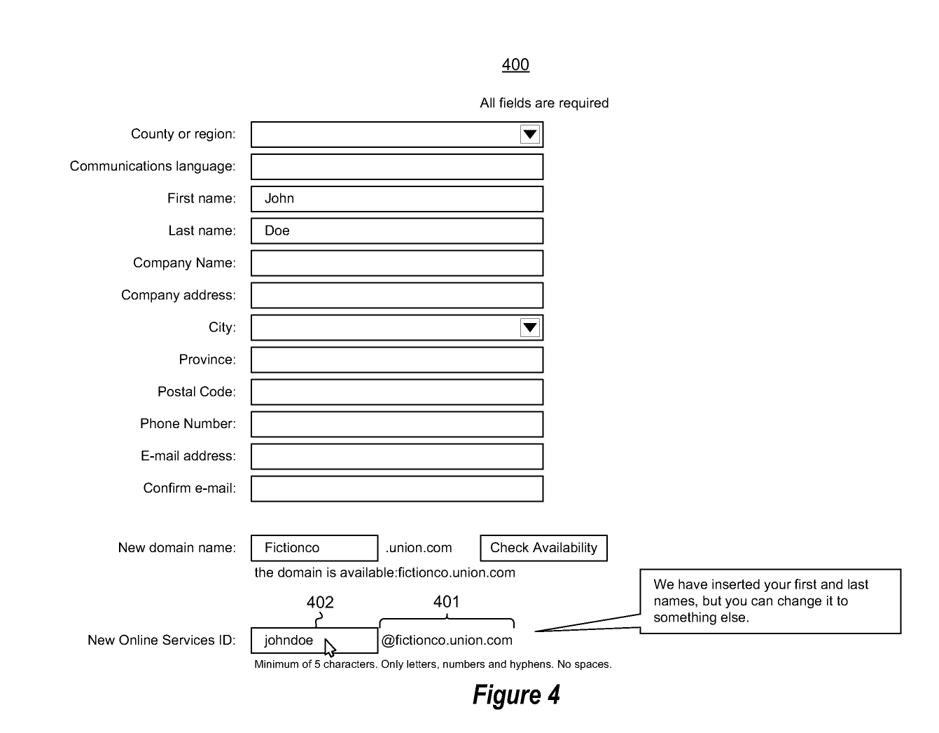

FIG. 4 illustrates a second user interface 400 that may be used to allow the user to select a prefix, which in combination with the third-level domain name chosen in the user interface of FIG. 3, creates a third-level e-mail address. The user interface 400 is an example of the user interface of act 203. The user interface 400 expands on the user interface 300 of FIG. 3, with the addition of an e-mail address formation field that includes a fixed portion 401 that represents the third-level domain name that was selected in the prior user interface 300, along with a text box 402 into which the prefix may be entered.

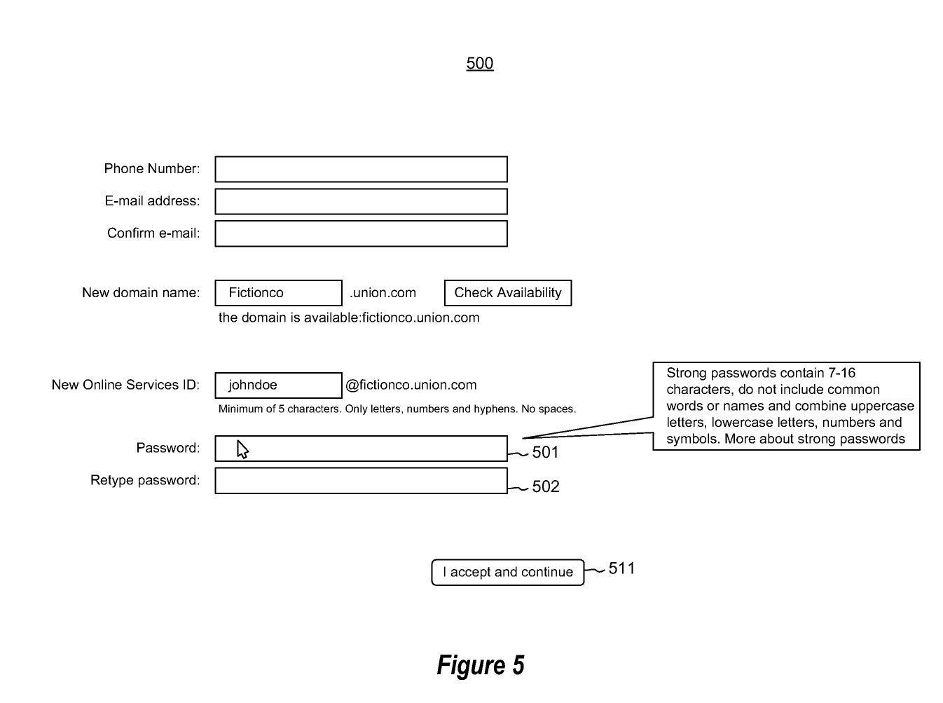

Returning to FIG. 2, the computing system then displays a third user interface in which the user enters a password (act 204) to be used in future authentication in association with the third-level e-mail address as an identifier. FIG. 5 illustrates such a third user interface 500. Here, the user may enter a password in text box 501, and confirm the password in text box 502. Upon selecting control 511, the third-level e-mail address becomes the identifier for one or more online services (act 205). In addition, the third-level e-mail address is used to provision an online service(s) (act 206).

Accordingly, a user interface is described that allows the user to formulate a third-level e-mail address that may be used to provision online services. Optionally, the third-level e-mail address may be associated with a second-level e-mail address belonging to the user that formulated the third-level e-mail address. This allows the user to revert to the more familiar second-level e-mail address if preferred. Thus, the user could use the second-level e-mail address, have the system correlate that to the third-level e-mail address, and further use that third-level e-mail address to provision the online services.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising one or more computer storage media having thereon computer-executable instructions that are structured such that, when executed by one or more processors of a computing system, cause the computing system to performing a method for assist a user in signing up for an online service using a third-level e-mail address for use in provisioning an online service, the method comprising:
an act of displaying a first user interface that permits a user to enter a third-level domain portion, which in connection with a first-tier domain portion, and a second-level domain portion, formulates a third-level domain name;
an act of verifying uniqueness of the third-level domain name;
an act of displaying a second user interface that permits a user to enter a prefix, which in combination with the third-level domain name creates a third-level e-mail address.

2. The computer program product in accordance with claim 1, wherein the act of displaying a first user interface comprises:
an act of displaying the first-tier domain portion and the second-level domain portion in context with the second-level domain portion preceding the first-tier domain portion.

3. The computer program product in accordance with claim 2, wherein the act of displaying a first user interface further comprises:
an act of displaying a text box in which the third-level domain portion is to be entered by the user in context preceding the second-level domain portion.

4. The computer program product in accordance with claim 1, wherein the act of verifying uniqueness of the third-level domain name comprises:
an act of verifying that there are no other identical third-level domain names used as identifiers for the online service.

5. The computer program product in accordance with claim 4, wherein the act of verifying uniqueness of the third-level domain name further comprises:
an act of verifying that there are no similar third-level domain names used as identifiers for the online service.

6. The computer program product in accordance with claim 1, wherein the act of displaying a second user interface that permits a user to enter a prefix comprises:
an act of displaying a text box that precedes the remaining portion of the third-level e-mail address in which the user may enter the prefix to complete the third-level e-mail address.

7. The computer program product in accordance with claim 1, wherein the method further comprises:
an act of using the third-level e-mail address as an identifier for an online service.

8. The computer program product in accordance with claim 1, wherein the method further comprises:
an act of using the third-level e-mail address as an identifier for multiple online services.

9. The computer program product in accordance with claim 1, wherein the method further comprises:
an act of using the third-level e-mail address to provision an online service.

10. The computer program product in accordance with claim 1, wherein the method further comprises:
an act of using the third-level e-mail address to provision multiple online services.

11. The computer program product in accordance with claim 1, wherein the method further comprises:
an act of displaying a third user interface in which the user enters a password to be used in future authentication in association with the third-level e-mail address as an identifier.

12. The computer program product in accordance with claim 1, wherein the method further comprises:
an act of associating the third-level e-mail address with a two-tier e-mail address belonging to the user that formulated the third-level e-mail address.

13. A method for a computing system assisting a user in signing up for an online service using a third-level e-mail address for use in provisioning an online service, the method comprising:
an act of displaying a first user interface that permits a user to enter a third-level domain portion, which in connection with a first-tier domain portion, and a second-level domain portion, formulates a third-level domain name;
an act of verifying uniqueness of the third-level domain name; and
an act of displaying a second user interface that permits a user to enter a prefix, which in combination with the third-level domain name creates a third-level e-mail address.

14. The method in accordance with claim 13, wherein the act of displaying a first user interface comprises:
an act of displaying the first-tier domain portion and the second-level domain portion in context with the second-level domain portion preceding the first-tier domain portion; and
an act of displaying a text box in which the third-level domain portion is to be entered by the user in context preceding the second-level domain portion.

15. The method in accordance with claim 13, wherein the act of verifying uniqueness of the third-level domain name comprises:
an act of verifying that there are no other identical third-level domain names used as identifiers for the online service; and
act of verifying uniqueness of the third-level domain name further comprises:
an act of verifying that there are no similar third-level domain names used as identifiers for the online service.

16. The method in accordance with claim 13, wherein the act of displaying a second user interface that permits a user to enter a prefix comprises:
an act of displaying a text box that precedes the remaining portion of the third-level e-mail address in which the user may enter the prefix to complete the third-level e-mail address.

17. The method in accordance with claim 13, wherein the act of displaying a second user interface that permits a user to enter a prefix comprises:
an act of displaying a text box that precedes the remaining portion of the third-level e-mail address in which the user may enter the prefix to complete the third-level e-mail address.

18. The method in accordance with claim 13, wherein the method further comprises:
an act of using the third-level e-mail address as an identifier for an online service.

19. The method in accordance with claim 13, further comprising:
an act of using the third-level e-mail address to provision multiple online services.

20. A computer program product comprising one or more computer storage media having thereon computer-executable instructions that are structured such that, when executed by one or more processors of a computing system, cause the computing system to performing a method for assist a user in signing up for an online service using a third-level e-mail address for use in provisioning an online service, the method comprising:
an act of displaying a first user interface that permits a user to enter a third-level domain portion, which in connection with a first-tier domain portion, and a second-level domain portion, formulates a third-level domain name, the first user interface including the first-tier domain portion and the second-level domain portion displayed in context with the second-level domain portion preceding the first-tier domain portion, and a text box in which the third-level domain portion is to be entered by the user in context preceding the second-level domain portion.
an act of verifying uniqueness of the third-level domain name;
an act of displaying a second user interface that permits a user to enter a prefix, which in combination with the third-level domain name creates a third-level e-mail address; and.
an act of using the third-level e-mail address as an identifier for an online service.
